(19) United States
(12) Patent Application Publication
(10) Pub. No.: US 2008/0114880 A1
(43) Pub. Date: May 15, 2008

(54) System for connecting to a network location associated with content

(76) Inventors: Fabrice Jogand-Coulomb, San Carlos, CA (US); Pascal A. Caillon, New York, NY (US); Benjamin Vigier, San Francisco, CA (US)

Correspondence Address: BRINKS HOFER GILSON & LIONE/SanDisk, P.O. BOX 10395, CHICAGO, IL, 60610, US

(21) Appl. No.: 11/600,006

(22) Filed: Nov. 14, 2006

(51) Int. Cl. G06F 15/16

(52) U.S. Cl. 709/227

(57) ABSTRACT

Computer-readable media storing operational instructions for connecting to a network location associated with content is disclosed. In one embodiment, a network location associated with content is obtained, the content is accessed, and a connection is made to the network location at a time other than when access to the content expires. In another embodiment, a network location associated with content is obtained, wherein the network location provides an online service other than offering access rights to the content. The content is accessed, and a connection is made to the network location. In yet another embodiment, a network location is selected from a plurality of network locations associated with content, the content is accessed, and a connection is made to the selected network location. In another embodiment, a network location associated with content is obtained, a determination is made, based on at least one rule, whether to connect to the network location, and the content is accessed. Other embodiments are disclosed, and each of the embodiments can be used alone or together in combination.

### BACKGROUND

A digital rights management (“DRM”) system can control access to content. When access to the content expires, a browser on the device accessing the content can connect to a resource at a particular network location (e.g., a website at a specific uniform resource locator (“URL”)) to give the user the opportunity to purchase access rights to the content. Consider, for example, the situation in which a user downloads a preview version of a song from a music website. The preview version can be protected by a DRM system so that the song can only be played a certain number of times. After the permission to play the song expires, a browser on the user's host device (e.g., a cell phone) can connect to the music website to allow the user to purchase additional or unlimited number of plays of the song.

### SUMMARY

The present invention is defined by the claims, and nothing in this section should be taken as a limitation on those claims.

By way of introduction, the embodiments described below provide computer-readable media storing operational instructions for connecting to a network location associated with content. In one embodiment, a network location associated with content is obtained, the content is accessed, and a connection is made to the network location at a time other than when access to the content expires. In another embodiment, a network location associated with content is obtained, wherein the network location provides an online service other than offering access rights to the content. The content is accessed, and a connection is made to the network location. In yet another embodiment, a network location is selected from a plurality of network locations associated with content, the content is accessed, and a connection is made to the selected network location. In another embodiment, a network location associated with content is obtained, a determination is made, based on at least one rule, whether to connect to the network location, and the content is accessed. Other embodiments are disclosed, and each of the embodiments can be used alone or together in combination.

The embodiments will now be described with reference to the attached drawings.

### BRIEF DESCRIPTION OF THE DRAWINGS

FIGS. 1A, 1B, and 1C are illustrations of a host device of an embodiment connecting to a network location associated with content.

FIG. 2 is an illustration of a system of an embodiment for connecting to a network location associated with content.

FIG. 3 is a flow chart of a method of an embodiment for connecting to a network location associated with content.

FIG. 4 is a flow chart of a method of an embodiment for obtaining a license and/or network location.

### DETAILED DESCRIPTION OF THE PRESENTLY PREFERRED EMBODIMENTS

The embodiments described herein allow a user to connect to a network location associated with content. As used herein, the phrase “network location” refers to an identifier that identifies a location on a network that contains a resource or information. A network location can be, for example, a uniform resource locator (“URL”) of a website on the Internet or an intranet address. Other network locations can be used. “Content” refers to digital media and can include, but is not limited to, an audio file, a video file (with or without audio), a game, a book, a map, a data file, or a software program. As also used herein, “access” is any action taken with respect to the content. Examples of various types of “access” include, but are not limited to, playing, displaying, printing, copying, and executing. However, “access” is something more than just determining the size or location of the content, determining that the content is ciphered, making a failed attempt to access the content, or reading information associated with the file (e.g., in a header) that describes the content of the file and how it should be handled. In some situations, access to the content can expire according to an access rule. The access rule can state, for example, that access to the content expires after the content has been accessed a certain number of times (e.g., after three plays), after a certain amount of time (e.g., after one week), or both (e.g., after three plays in one week). Content in which access expires according to an access rule may sometimes be referred to herein as “preview content.”

As mentioned in the background section above, some existing DRM systems use a network location to provide a user with a mechanism to purchase additional access rights to content after access to the content has expired. The use of a network location in this manner is somewhat limited, and the embodiments described herein provide additional uses of network location(s) associated with content. In one embodiment, instead of connecting to a network location after access to content has expired, a connection to the network location is made at some earlier time. For example, connection to a network location can be made after the content has been accessed, before the content is accessed, or while the content is being accessed. By removing the restriction that a connection to a network location should only be made after content access has expired, this embodiment provides the advantage of directing traffic (and potentially revenue) to the network location faster than with approaches where connection to the network location is made only after access to content has expired. The network location being connected to in this embodiment can be one in which a user can purchase additional access rights to content. However, the network location can also be for different online services, as described below.

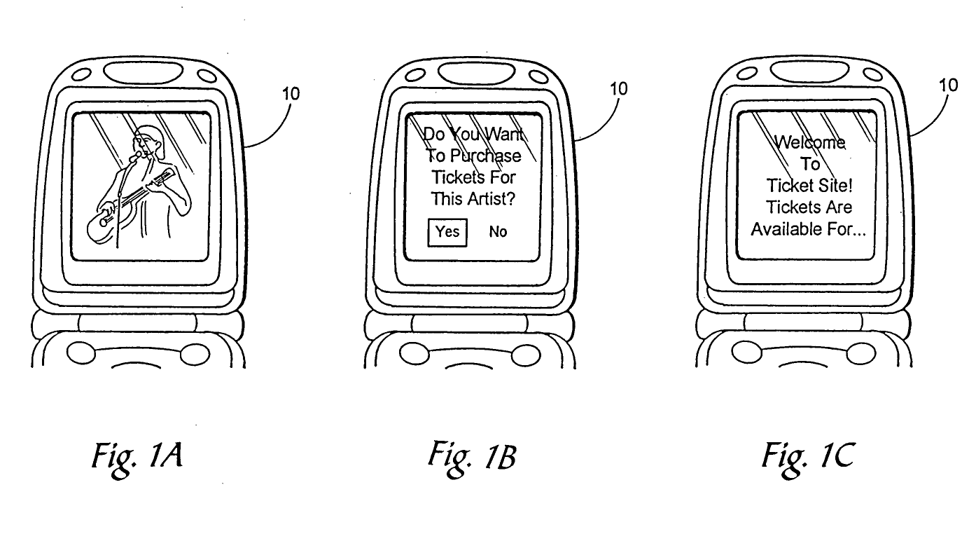

In another embodiment, the network location can be associated with a resource that, in addition to or instead of providing an outlet for a user to purchase additional access rights to content, provides another type of online service. (In this and other embodiments, the connection to the network location can be made at any time—not necessarily before access to content expires, as in the previous embodiment.) This embodiment will be illustrated in conjunction with FIGS. 1A-1C.

In FIG. 1A, a cell phone 10 is playing a music video for a user. As shown in FIG. 1B, at the end (or after the access whether the end was reached or not) of the video (or at some other time (e.g., after the fifth play of the video)), the user is asked if he wants to purchase tickets to see the artist in concert. If the user answers in the affirmative, he is connected to a network location that allows him to purchase the concert tickets (see FIG. 1C). In addition to providing an online ticket service, this network location can also provide an outlet for a user to purchase additional access rights to the music video. In another example, the content takes the form of a movie trailer, and the user is connected to a movie ticket website through which the user can purchase tickets for the movie. As in the above example, the movie ticket website may or may not offer the user the option of extending access rights to the movie trailer, if access rights to the movie trailer can expire (e.g., if the movie trailer can only be played ten times). In all of these examples, the user is allowed to discover an online service that provides something more than just the opportunity to obtain additional access rights to the content associated with the network location. It can also be used to initiate a download of an application after the cell phone connects to a network address (e.g., the remote server can identify the handset and then push an application to the user that is then installed on the handset). In contrast, with some prior DRM systems, the sole purpose of the network location is to provide a user with an outlet to acquire additional access to the content. Additionally, as noted above, connection to the network locations of these additional online services can take place prior to or after access expiration of the underlying content, if the underlying content is restricted by an access rule.

In another embodiment, instead of being associated with a single network location, content can be associated with a plurality of network locations, and connection can be made to a network location (and, possibly, a series of two or more network locations) selected from this plurality. (Accordingly, the phrases “selecting/obtaining a network location” and “connecting to that network location” do not precluding selecting/obtaining and connecting to two or more selected/obtained network locations.) Providing a plurality of network locations provides a multitude of online services for users to discover and can provide different network locations for different occasions. Any suitable selection criteria can be used, including, but not limited to, information about the host (e.g., operating system parameters, screen size, type of processor, etc.), information about the last time a connection was made to the network location, information associated with the content, the time/date that connection is proposed, and identification of the user.

To illustrate this embodiment, consider the situation in which selection is based on a network identifier stored in a subscriber identification module (“SIM”) card in a cell phone. The network identifier specifies a particular mobile network operator (“MNO”) (e.g., Cingular Wireless or Verizon Wireless). In this example, a mobile-network-operator-independent cell phone store has a promotional event. In this promotional event, when signing-up for a mobile contract, content is offered on a removable memory card provided with the cell phone, and the content is associated with multiple network locations: a network location for MNO1, a network location for MNO2, and a default network location. (The resources at some or all of these network locations can be different from or the same as each other.) So, if a customer purchases a cell phone and signs-up for MNO1, at the appropriate time, his cell phone would choose and connect to the network location for MNO1; whereas if the customer purchases a cell phone and signs-up for MNO2, at the appropriate time, his cell phone would choose and connect to the network location for MNO2. If, however, the customer signs-up for MNO3, which is not associated with a customized network location, at the appropriate time, his cell phone would choose and connect to the default network location, which could be supported by the mobile-network-operator-independent cell phone store, for example. This can help promote the adequate operator services and leverage the operator billing system, if needed. The selection of the adequate network location could be done by having each location identified with a pre-define code that would match the host application or by using a specific naming convention, for example. For example, a mobile operator configuration could be associated with the network ID from the IMSI, on a PC by having the host specify the OS, etc.

As mentioned above, the selection of a network location can be based on any suitable criteria and not necessarily on an MNO (i.e., a service operator). For example, the selection of a network location can be based on information about the host, such as operating system parameters, screen size, or processor type, and information from a SIM card. Consider the situation in which content is stored on a portable memory device, and a user wishes to access the content some times on his cell phone and other times on his PC. The information about the host device (e.g., the host device is a cell phone because it is using Windows Mobile, or the host device is a PC because it is using Windows XP) can be used to select the network location appropriate for the cell phone or for the PC. For instance, one network location may be optimized for small screen sizes, while another network location is for a standard web page that would not be displayable on a cell phone. Using information about the host can help ensure that the appropriate network location is used. Of course, other selection criteria can be used. For example, the time/date that connection is proposed can determine which holiday-themed web page to connect to (e.g., a Halloween-themed web page in October versus a Thanksgiving-themed web page in November). As another example, there can be different network locations available for different users, with a particular network location being selected based on the identification of the user, which can be stored, for example, in a SIM card. In this way, a web page more enticing to teenagers can be selected for a teenage user, and a web page more enticing to adults can be selected for an adult user.

It should be noted that, in some situations, even though there are a plurality of network locations associated with content, none of the plurality of network locations may be suitable. For example, if all of the network locations, including the default network location, are for standard web pages that would not be displayable on a cell phone, and the user is using a cell phone, a connection option may not be proposed (or the user may be asked to manually enter a suitable location).

As mentioned above, connection to a network location can take place at any suitable time. In some embodiments, the connection is made before access to content has expired, while, in other embodiments, the connection is made after access to content has expired. Additional rules can be used to determine when a connection is to be made (or proposed to be made). As used herein, “a rule” refers to either a single rule or a set of two or more rules. A rule can be based on any suitable criteria, including, but not limited to, information about the last time a connection was made to a network location, information about the host, information about the user, information about what the user did the last time he interacted with the network location, information from a SIM card, and service operator information. For example, a rule can specify that connection to a network location should be made every time content has been accessed, only once a day, after any five plays, after five plays in one week, etc. In this way, even though there is a suitable network location available (e.g., an MNO1 network location for an MNO1 user), the connection to that network location will not be made if the rule states that the connection should not be made (e.g., because connection can be made only once a day, and a connection had already been made earlier that day). As another example of a rule based on information from a SIM card, the rule may state that a connection is to be made to a particular URL only once a day if a SIM card from Operator A is being used; otherwise, a connection is always to be made to the URL (or to a different URL) if a SIM card from any other operator is being used. To complement the rule, the last access to the content (e.g., for a given configuration) could be stored back in the content or its license to allow tracking when connection should be proposed.

A rule can also specify, for example, that connection to a network location is only to be made more than once a day if different host devices are being used. In this way, connection to a network location can be made more than once a day if the content was first accessed on the user's cell phone and then, during the same day, on his PC. The network location that the cell phone connects to can be the same as or different from the network location that the PC connects to (based on the different properties of the different host devices (e.g., screen sizes and operating systems)). As another example, the rule can be based on what the user did the last time he interacted with the network location. In this way, in the previous example from FIGS. 1A-1C, if the user purchased concert tickets when he was connected to the ticket website, the rule can prevent the user from subsequently being asked if he wants to connect to the ticket website. Finally, it should be noted that even in situations where the user is not asked to connect to a network location (either because of a rule or because there is not a suitable network location available), a user can be given the choice to manually connect to the network location (e.g., via a menu.)

It should be noted that various aspects of these embodiments can be used alone or in combination. For example, connection to a network location can be made before or after access to content expires (if such access expires) with or without using a rule (e.g., connect after each play, connect only once a day, etc.), where the network location can be a single network location or selected from a plurality of network locations, some or all of which can be related or unrelated to providing access rights to content. It should also be noted that a connection to a network location can be made automatically, after the user is asked if a connection should be made and answers in the affirmative, or in response to the user manually entering the network location.

With some of the embodiments now generally described, the following is a discussion illustrating a presently preferred implementation. It should be noted that this discussion is one or many implementations of these embodiments and that the implementation details described herein should not be read into the claims unless explicitly recited therein.

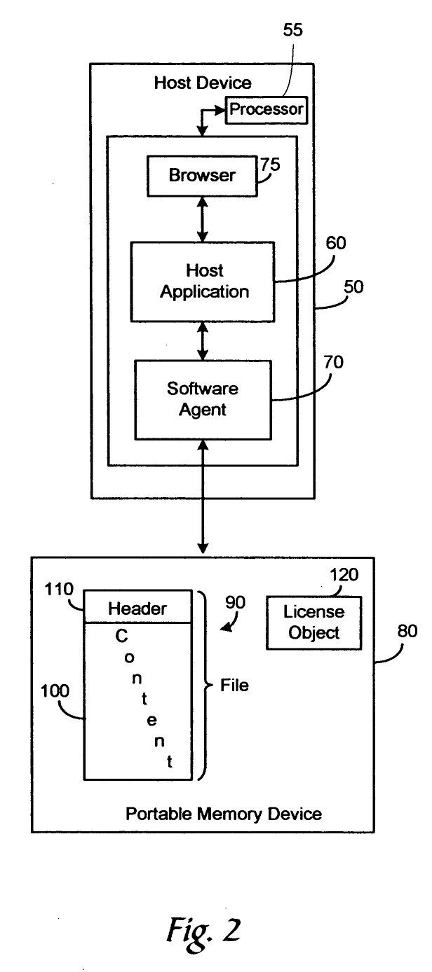

Returning to the drawings, FIG. 2 is an illustration of a system of an embodiment for connecting to a network location associated with content. The system comprises a host device 50 and a portable memory device 80. As used herein, a “host device” is any device that can be used to access content and includes, but is not limited to, a cell phone, a PC/notebook computer, a handheld computer, a handheld game console, an audio player (e.g., an MP3 player), a video player (e.g., a DVD player or a portable video player), an audio and/or video recorder, a digital camera, a set-top box, a display device (e.g., a television), a printer, a car stereo, and a navigation system. The host device 50 in FIG. 2 comprises one or more processors 55 executing a host application 60, a software agent 70, and a browser 75. As used herein, a “host application” refers to any application that can be used to access content. Examples of a host application include, but are not limited to, an audio player, a video player, and a document viewer. In addition to accessing content, a host application can have other functions, such as downloading content and storing information on a portable memory device.

The host application 60 may not be able to read certain types of content (such as protected content or content that is otherwise not accessible with the host application 60 alone), and the software agent 70 is an interface that allows the host application 60 to access such types of content. The software agent 70, which may sometimes be referred to herein as a “software development kit (SDK)” or a “toolkit,” acts as a library that the host application 60 (or other components in the host device 50) uses to access content or otherwise interact with a portable memory device. For example, the software agent 70 can contain security management functionality, such as login and decrypting mechanisms. As described below, the software agent 70 can also play a role in accessing content. The browser 75 is an application operative to connect to a network location (e.g., connect to and display a web site identified by a URL).

The host application 60, software agent 70, and browser 75 can be implemented as computer-readable instructions stored on a computer-readable medium and executed by one or more processors 55 on the host device 50. Although the browser 75 and the host application 60 are shown as separate components, in an alternate embodiment, the browser 75 is part of the host application 60. Other components of the host device 50, such as a display device and driver(s), are not shown in FIG. 2 for simplicity.

FIG. 2 shows the host device 50 in communication with a portable memory device 80. The portable memory device 80 stores a file 90, which comprises content 100 and a header 110, and a license object 120. In general, a portable memory device is any device that contains a storage medium that can store content and be put in communication with a host device that can access the content stored in the storage medium. A portable memory device can contain only memory (and associated circuitry) or can also contain other components, such as a processor. Examples of portable memory devices include, but are not limited to, a removable memory card (e.g., a non-volatile, solid-state memory device, such as a flash memory card), an optical disc, a magnetic disk, as well as any of the examples of host devices listed above, when those devices have a storage medium and the capability of being placed in communication with a host device to access information stored in the storage medium. Accordingly, a “host device” in some situations can be a “portable memory device” to another host device in other situations. For example, in some situations, a cell phone can be used as a host device (as in FIGS. 1A-1C). However, in other situations, a cell phone can be used as a portable memory device when the cell phone is connected to a personal computer so content can be delivered from the cell phone to the personal computer. As can be seen from these examples, a portable memory device can serve as a dedicated storage device or can contain additional functionality, such as playing music, making phone calls, etc.

It should be noted that a portable memory device is not necessarily needed to provide content and/or a license to the host device 50. For example, content and/or a license can be downloaded from a server to the host device 50, can be wirelessly transmitted to the host device 50 from another host device, or can be “sideloaded” from a PC (e.g., downloaded onto a PC and then moved to the portable memory device 80). Accordingly, a portable memory device is not necessarily needed to practice these embodiments and should not be read into the claims unless explicitly recited therein.

Returning to FIG. 2, the header 110 contains information about the file 90 and can identify, for example, whether the content 100 is encrypted, whether the content 100 is protected by a digital rights management (DRM) system, where to find the license object 120, and where to log-in to perform DRM authentication. The license object 120 (or “license” or “content license”) is an entity that stores permissions or restrictions regarding the access of the content 100, if the content 100 is protected by DRM. For example, the license object 120 can restrict the number of times the content 100 can be accessed or set an expiration date and time for such access. As described below, the license object 120 may not be present if the content is not protected by DRM. It should be noted that “object” is being used herein as a generic description of an entity (e.g., a file, a part of a file, etc.) and can be, but is not necessarily, an “object” in the object-oriented programming sense. Also, while the license object 120 is shown as being stored on the portable memory device 80, it should be understood that the license object 120 can be stored in any suitable location, such as the host device 50 or a device accessible via a network. Accordingly, the content and the license do not need to be stored on the same device.

In this embodiment, the content 100 is associated with at least one network location. These network location(s) can be stored at any suitable location. For example, the network location(s) can be stored in the header 110 of the file 90, in a footer of the file 90, in some portion of the content 100, in the license object 120, and in a location external to the file 90 (e.g., in a separate file). Further, the network location(s) can be stored in the host device 50, in the portable memory device 80, or in some other location (e.g., a storage device in a network). When multiple network locations are used, they can be all stored together, or one or more of the network locations can be stored separately from the other network locations. For simplicity, in the following illustration of these embodiments, the content 100 is associated with a plurality of network locations, which are all stored together either in the header 110 or the license object 120. It should be noted that other information can be stored along with the network location. For example, it may be preferred to store a friendly nickname along with the network location. In this way, if the host application 60 asks the user if he wishes to connect to the network location (e.g., in situations where a user will be charged for the connection), the host application 60 can display the friendly nickname (e.g., “Ticket Website”) instead of the actual network location, which can be long and not easily recognizable by the user.

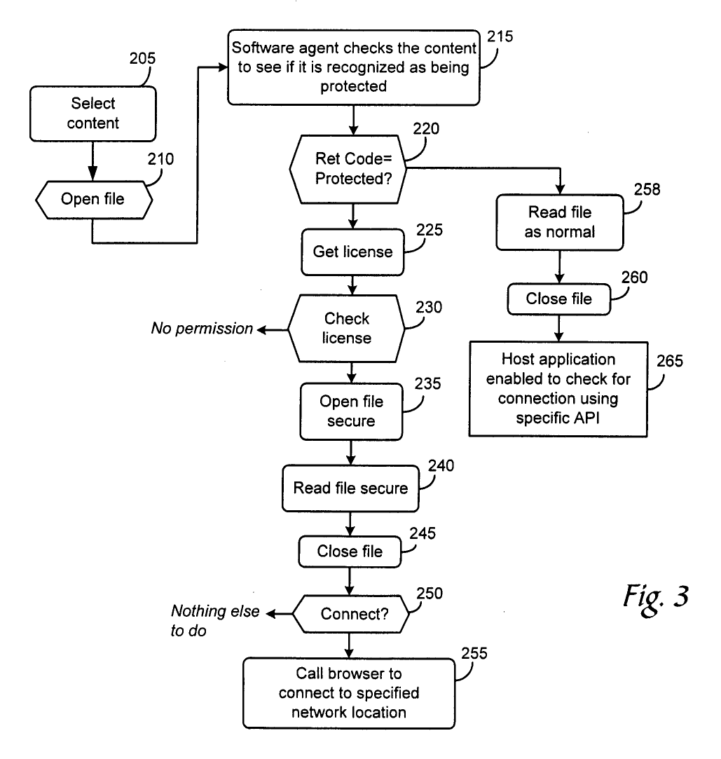

Turning again to the drawings, FIG. 3 is a flowchart of a method of an embodiment for connecting to a network location associated with content. As shown in FIG. 3, the first act in this method is to select content (act 205). Content can be selected in any suitable manner. For example, the host application 60 (or another application) on the host device 50 can present a user with a menu of content options for the user to manually select the content. Many alternatives can be used. For example, instead of using a menu, the user can type-in the name of the content he wants to select, or the content can be automatically selected for the user (as when the host application 60 automatically selects content based on prior selection choices made by the user). After the content 100 has been selected, the host application 60 issues an “open file” command to the software agent 70 to open the file 90 (act 210). The software agent 70 then checks the content 100 to see if it is recognized by the software agent 70 as being protected (act 215). This can be done, for example, by reading the header 110 of the file 90. The software agent 70 sends the appropriate code back to the host application 60, and the host application 60 determines if the returned code states “protected” (act 220).

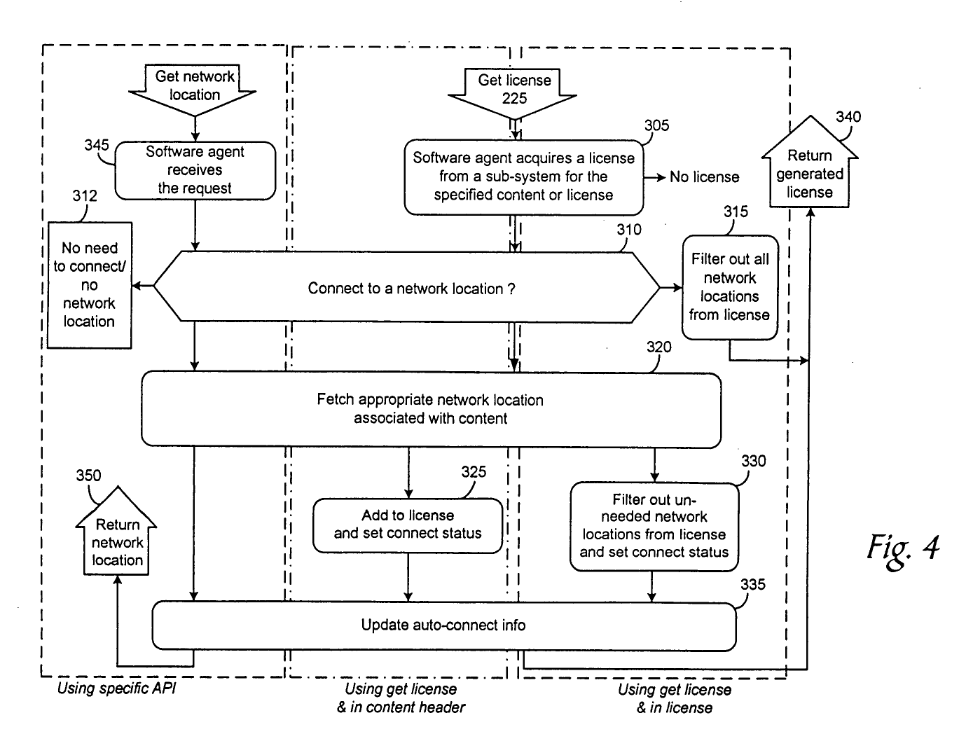

If the returned code states “protected,” the host application 60 then sends a “get license” command to the software agent 70 (act 225). FIG. 4 is a flow chart that illustrates the acts performed in response to the “get license” command. (FIG. 4 also contains additional information that will be described below.) As shown in FIG. 4, in response to the “get license” command, the software agent 70 acquires the appropriate license from a sub-system for the specified content or license (act 305). The term “sub-system” refers to the entity that performs DRM and checks permissions. This sub-system can be on the host device 50, on the portable memory device 80, on another device (e.g., in a network), or distributed among one or more of these devices. For example, the sub-system can be a DRM agent in the software agent 70 that connects to the portable memory device 70, reads the license 120 from the portable memory device 70, checks the permissions, and then provides the license 120 to the host application 60. As another example, the portable memory device 70 can comprise a processor that executes its own DRM agent. In such an embodiment, the software agent 70 can ask the DRM agent running on the portable memory device 80 if the host application 60 is allowed to access the content. The DRM agent would then internally fetch the license, check the permissions, and provide the appropriate license to the software agent 70. Also, “for the specified content or license” mentioned in the flow chart refers to the fact that the license can be named (or specified) after the content name or after a license identifier, either of which can be located in the information associated with the file 90 (e.g., in the header 110 or in another location).

If the software agent 70 determines there is no license, the software agent 70 will communicate that determination back to the host application 60 (act 312), and the host application 60 can attempt to acquire a license and get permissions on its own. If the software agent 70 acquires the license, it (or some other entity, such as a DRM module on the host 50) will then determine whether to connect to a network location (act 310). In this embodiment, a rule is used to determine whether a connection should be made to the network location. As used herein, “rule” can refer to a single rule or a set of two or more rules and can specify when a connection to a network location should be made or when a proposal should be made to the user to make a connection. The rule can be stored in one or more locations. For example, the rule can be stored in the content (e.g., the rule can be protected in the content header) or in the license for the content, so each content would come with its own rule (e.g., one content can have a rule for connecting after each access, while another content can have a rule for connecting after the content has been accessed five time, while yet another content can have a rule for connecting every day). The rule can also be on the portable memory device 80 as a global rule for all content stored on that portable memory device 80. In this way, different portable memory devices can have different rules. In yet another example, the rule can be part of the software agent 70 (e.g., the software agent 70 can be preconfigured to only connect only once per day) or on the host device 50. The rule can also be received from a server along with the license for the content.

In this embodiment, the rule specifies whether or not a connection is to be made based on information about the host 50 and/or information about the last time there was a connection to a network location. In other embodiments, different or additional factors can be used (e.g., based on whether or not access to the content has expired, based on information associated with the content). Information about the host 50 can include, but is not limited to, mobile network operator, type of host (e.g., handset or PC), type of processor, screen size, and operating system parameters (e.g., Windows Mobile or Windows XP). The host information is preferably stored in the host 50 (e.g., on a SIM card in the host 50) but can be stored in other locations, if desired. The information about the last time there was a connection to a network location can include, but is not limited to, the date and/or time the last connection was made, and information about the host that was used to make the connection (e.g., what SIM card, what operating system, etc.). This information can be stored in any suitable location (e.g., in the content, in the license for the content, or on the portable memory device) that can be accessed when the content is accessed and is preferably updatable so the last connect information can be updated.

As mentioned above, in this embodiment, the rule specifies whether or not a connection is to be made based on information about the host 50 and/or information about the last time there was a connection to a network location. For example, a rule can state that a connection to a network location is to be made only once a day and only if the host device is a cell phone. If it is determined that a connection to a network location is not to be made and the network location is stored in the content header 110, a message indicating that there is no need to connect is returned (act 312). If it is determined that a connection to a network location is not to be made and the network location is stored in the license 120, all of the network locations are filtered out of the license 120 (or the single network location is filtered out, if only one network location is stored) (act 315), and the generated license is returned (act 340).

If, however, it is determined that a connection to a network location is to be made, the appropriate network location (from the possible network locations) is fetched (e.g., with the software agent 70 or some other entity, such as a DRM module on the host 50) (act 320). The “appropriate” network location can be, for example, a network location that is compatible with the host environment (e.g., for a cell phone, a URL for a small-screen-size web site instead of a URL for a normal-screen-size web site). Accordingly, the same content can connect a user to different network locations depending on what host environment is being used. As noted above, the network location associated with the content can be stored in any suitable location, including, but not limited to, the header 110 of the content 100, the license 120, or some other location. The network location can be fetched from these locations by the software agent 70 directly, or the software agent 70 can send a request for the network location to an agent running in the portable memory device 80, which can fetch the network location and return it to the software agent 70.

With the appropriate network location fetched, the next act depends on whether the network locations were stored, for example, in the content header 110 or in the license 120. If the network locations were stored in the content header 110, the fetched network location is added to the license 120, and a “connect status” flag is set indicating that connection should be made to the network location (act 325). If the network locations were stored in the license 120, the unneeded network locations are filtered from the license 120, and a “connect status” flag is set indicating that connection should be made to the network location (act 330). It may be preferred to make the network location and the “connect status” flag secure to prevent unauthorized changes. For example, the network location (and other important content information) could be hashed, and the signed hash could be associated with the content. Thus, changing the network location would prevent access to the content. (In addition to protecting the selected network location, the plurality of network locations can also be protected.)

At the end of either of these acts, the last connect information is updated to reflect that a connection will be made (act 335). (In other embodiments, the last connect information is updated after (instead of before) the connection has been made.) Then, the generated license is returned (act 340). The generated license is a modified version of the license object 120 in that it contains only the network location that is to be connected to and, possibly, additional permissions/restrictions (such as “cannot copy”).

Returning to the flowchart in FIG. 3, with the license returned, the license is checked to see if there is permission to access the content (act 230). If there is permission, the file 90 is opened in a secure manner (act 235), and the file 90 is read in a secure manner (act 240) (i.e., the content 100 is accessed). After the file is closed (act 245), it is determined if a connection to a network address is to be made (act 250). This determination can be made in any suitable manner. For example, in one embodiment, the host application 60 is enabled to perform this function and checks the “connect status” flag using a specific application programming interface (“API”), a license, or an open-parameter (e.g., from the open file secure act). (The use of an API is described in more detail below.) In another embodiment, a DRM module running on the host 50 updates the license and then makes this determination (by checking the license or using a specific API to get that information). If a connection is to be made, the DRM module calls the browser 75 to connect to the network location specified in the generated license (act 255). In yet another embodiment, the software agent 70 can make this determination when the file 90 is closed. (It should be noted that while the determination is being made in these examples after the file 90 is closed, the determination (and subsequent connection) can be made before the file 90 is closed.)

In the above example, a generated license was used as the vehicle to supply a selected network location to the browser on the host 50. Referring once again to decision block 220 in FIG. 3, if the returned code does not state “protected,” a license would not be generated, and the host application 60 would read the file 90 (i.e., access the content 100) as normal (act 258) and then close the file (act 260). In order to provide a connection option in this situation where a license is not generated, after the file is closed, the host application 60 can use an API to determine if a connection to a network location should be made (act 265). In operation, the API would issue a “get network location” command to the software agent 70. With reference to FIG. 4, after the software location 70 receives the request (act 345), it determines whether a connection to a network location should be made using the procedure described above (act 310). (In other embodiments, a different procedure can be used.) However, after the appropriate network location has been fetched (act 320), instead of adding the network location to the license or filtering out network locations from the license, the last connect information is updated (act 335), and the network location is returned to the host application 70, which passes it to the browser 75 for connection.

It should be noted that these embodiments can be used in any suitable application. One such application relates to providing access to content after preview content has been accessed. Additional information about the use of preview content can be found in “Method for Allowing Multiple Users to Access Preview Content,” U.S. patent application Ser. No. ______ (atty. dkt. no. 10519-180), and “System for Allowing Multiple Users to Access Preview Content,” U.S. patent application Ser. No. ______ (atty. dkt. no. 10519-191), both of which are being filed on the same date as the present patent application, are assigned to the assignee of the present invention, and are hereby incorporated by reference. When the content comprises preview content, the network location can allow access to the full version of the content by allowing a user to download a new license (if the user already has the full version of the content) or download both a new license the full version of the content.

It should also be noted that some of the acts described herein can be performed in a different order. For example, the act of selecting a network location can occur before or after the act of accessing the content. Accordingly, the acts described in the specification and recited in the claims should not be read as requiring a specific order unless explicitly mentioned. Further, while certain acts were described herein as being performed by the software agent, host application, browser, API, or host, it should be noted that these acts can be performed by different entities named or unnamed herein. For example, an environment can be designed such that some or all of the acts performed in the examples by the software agent are instead performed by the host application. Additionally, the host and/or portable memory devices can have other components that perform some or all of the acts. For example, the host or the portable memory device can have a DRM module that checks permissions and updates the license object. Accordingly, performance of the acts described herein can be distributed in any suitable fashion. Further, while these embodiments can be implemented in any suitable environment, it is presently preferred that these embodiments be implemented on a TrustedFlash™ platform by SanDisk Corporation.

In one embodiment, a computer-readable storage media stores computer-readable operational instructions (i.e., computer-readable program code) to perform the acts involved in these embodiments. Examples of computer-readable storage media include, but are not limited to, a solid-state storage device, an optical storage device (e.g., a CD or DVD), and a magnetic storage device (e.g., a hard drive). The phrase “computer-readable storage media” is intended to cover either a single storage medium or a plurality of storage media in one or more devices. Accordingly, “computer-readable storage media” can be located in the host device or the portable memory device or both, for example. In one embodiment, the portable memory device can contain computer-readable storage media that carries the operational instructions (i.e., computer-executable code) to implement the software agent. These instructions can be provided to the host device when the portable memory device is put into communication with the host device. These instructions are then stored in computer-readable storage media of the host device. In this way, the software agent can be placed on a host device in a plug-and-play fashion. In another embodiment, the software agent is pre-loaded onto the host device, so the computer-readable storage media in the host device would carry the operational instructions to implement the software agent when sold to the end user.

In any situation, the operational instructions can be executed by one or more processors in the host device, portable memory device, or some other device (e.g., a computer in the network). Further, as mentioned above, the performance of the acts can be distributed. For example, a processor in the portable memory device can execute some of the operational instructions (stored in the computer-readable storage media in the portable memory device or the host), while the processor in the host device can execute other ones of the operational instructions (stored in the computer-readable storage device in the portable memory device or the host). Additionally, instead of being stored in computer-readable media and executed by a processor(s), some or all of the operational instructions can be implemented in hardware. For simplicity, the term “circuitry” will be used herein to cover a purely hardware implementation, a purely software implementation, and/or an implementation that uses both hardware and software. Accordingly, “circuitry” can take the form of a processor and computer-readable program code that is stored in a computer-readable medium and is executable by the processor. “Circuitry” can also take the form of an application specific integrated circuit (ASIC), a programmable logic controller, an embedded microcontroller, and a single-board computer. Accordingly, the term “circuitry” should not be limited to any particular type of implementation, described herein or otherwise. Further, “circuitry” should not be limited to performing the functions described herein. For example, when circuitry takes the form of a processor executing firmware, it should be understood that the processor can perform functions in addition to the ones described above.

The following patent documents contain embodiments that can be used with the embodiments described herein. Each of these patent documents is being filed on the same date as the present application, is assigned to the assignee of the present invention, and is hereby incorporated by reference: “Methods for Linking Content with License,” U.S. patent application Ser. No. ______ (atty. dkt. no. SAN-017); “Apparatuses for Linking Content with License,” U.S. patent application Ser. No. ______ (atty. dkt. no. SAN-020); “Methods for Accessing Content Based on a Session Ticket,” U.S. patent application Ser. No. ______ (atty. dkt. no. SAN-021); “Apparatuses for Accessing Content Based on a Session Ticket,” U.S. patent application Ser. No. ______ (atty. dkt. no. SAN-022); “Methods for Binding Content to a Separate Memory Device,” U.S. patent application Ser. No. ______ (atty. dkt. no. SAN-018); “Apparatuses for Binding Content to a Separate Memory Device,” U.S. patent application Ser. No. ______ (atty. dkt. no. SAN-023); “Method for Allowing Multiple Users to Access Preview Content,” U.S. patent application Ser. No. ______ (atty. dkt. no. 10519-180); “System for Allowing Multiple Users to Access Preview Content,” U.S. patent application Ser. No. ______ (atty. dkt. no. 10519-191); “Method for Allowing Content Protected by a First DRM System to Be Accessed by a Second DRM System,” U.S. patent application Ser. No. ______ (atty. dkt. no. 10519-181); “System for Allowing Content Protected by a First DRM System to Be Accessed by a Second DRM System,” U.S. patent application Ser. No. ______ (atty. dkt. no. 10519-190); and “Method for Connecting to aNetwork Location Associated with Content,” U.S. patent application Ser. No. ______ (atty. dkt. no. 10519-182).

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. Computer-readable media storing operational instructions for connecting to a network location associated with content by:
(a) obtaining a network location associated with content;
(b) accessing the content; and
(c) connecting to the network location associated with the content at a time other than when access to the content expires.

2. The computer-readable media of claim 1, wherein the network location is stored in a license for the content, and wherein the operational instructions further remove additional network locations from the license.

3. The computer-readable media of claim 1, wherein the operational instructions further add the network location to a license for the content.

4. The computer-readable media of claim 3, wherein the network location is stored in a header of a file storing the content.

5. The computer-readable media of claim 1, wherein (a) comprises selecting the network location from a plurality of network locations.

6. The computer-readable media of claim 1, wherein the network location offers access rights to the content.

7. The computer-readable media of claim 1, wherein the network location provides an online service other than offering access rights to the content.

8. The computer-readable media of claim 1, wherein (c) is performed after it is determined, based on at least one rule, to connect to the network location.

9. The computer-readable media of claim 1, wherein the network location comprises a uniform resource location (URL) of a web site.

10. Computer-readable media storing operational instructions for connecting to a network location associated with content by:
(a) obtaining a network location associated with content, wherein the network location provides an online service other than offering access rights to the content;
(b) accessing the content; and
(c) connecting to the network location associated with the content.

11. The computer-readable media of claim 10, wherein the network location also offers access rights to the content.

12. The computer-readable media of claim 10, wherein the network location is stored in a license for the content, and wherein the operational instructions further remove additional network locations from the license.

13. The computer-readable media of claim 10, wherein the operational instructions further add the network location to a license for the content.

14. The computer-readable media of claim 13, wherein the network location is stored in a header of a file storing the content.

15. The computer-readable media of claim 10, wherein (a) comprises selecting the network location from a plurality of network locations.

16. The computer-readable media of claim 10, wherein (c) is performed at a time other than when access to the content expires.

17. The computer-readable media of claim 10, wherein (c) is performed after access to the content expires.

18. The computer-readable media of claim 10, wherein (c) is performed after it is determined, based on at least one rule, to connect to the network location.

19. The computer-readable media of claim 10, wherein the network location comprises a uniform resource location (URL) of a web site.

20. Computer-readable media storing operational instructions for connecting to a network location associated with content by:
(a) selecting a network location from a plurality of network locations associated with content;
(b) accessing the content; and
(c) connecting to the selected network location.

21. The computer-readable media of claim 20, wherein (a) comprises selecting the network location based on information about a host device.

22. The computer-readable media of claim 21, wherein the information about the host device comprises one or more of an operating system parameter, a screen size, and a type of processor.

23. The computer-readable media of claim 20, wherein the network location offers access rights to the content.

24. The computer-readable media of claim 20, wherein the network location provides an online service other than offering access rights to the content.

25. The computer-readable media of claim 20, wherein the plurality of network locations are stored in a license for the content, and wherein the operational instructions further remove non-selected network locations from the license.

26. The computer-readable media of claim 20, wherein the operational instructions further add the selected network location to a license for the content.

27. The computer-readable media of claim 26, wherein the plurality of network locations are stored in a header of a file storing the content.

28. The computer-readable media of claim 20, wherein the selected network location offers access rights to the content.

29. The computer-readable media of claim 20, wherein the selected network location provides an online service other than offering access rights to the content.

30. The computer-readable media of claim 20, wherein (c) is performed at a time other than when access to the content expires.

31. The computer-readable media of claim 20, wherein (c) is performed after access to the content expires.

32. The computer-readable media of claim 20, wherein (c) is performed after it is determined, based on at least one rule, to connect to the network location.

33. The computer-readable media of claim 20, wherein the selected network location comprises a uniform resource location (URL) of a web site.

34. Computer-readable media storing operational instructions for connecting to a network location associated with content by:
(a) obtaining a network location associated with content;
(b) determining, based on at least one rule, whether to connect to the network location associated with the content;
(c) accessing the content; and
(d) connecting to the network location if it is determined, based on the at least one rule, to connect to the network location.

35. The computer-readable media of claim 34, wherein the at least one rule is based at least in part on a last time a connection was made to the network location.

36. The computer-readable media of claim 34, wherein the at least one rule is based at least in part on whether access to the content has expired.

37. The computer-readable media of claim 34, wherein the network location offers access rights to the content.

38. The computer-readable media of claim 34, wherein the network location provides an online service other than offering access rights to the content.

39. The computer-readable media of claim 34, wherein the network location is stored in a license for the content, and wherein the operational instructions further remove additional network locations from the license.

40. The computer-readable media of claim 34, wherein the operational instructions further add the network location to a license for the content.

41. The computer-readable media of claim 40, wherein the network location is stored in a header of a file storing the content.

42. The computer-readable media of claim 34, wherein the operational instructions further select the network location from a plurality of network locations.

43. The computer-readable media of claim 34, wherein the network location comprises a uniform resource location (URL) of a web site.

44. The computer-readable media of claim 1, wherein the content comprises preview content, and wherein the network location allows a user to download a full version of the content.

45. The computer-readable media of claim 20, wherein (a) comprises selecting the network location based on information from a SIM card.

46. The computer-readable media of claim 20, wherein (a) comprises selecting the network location based on information from a service operator.

47. The computer-readable media of claim 27, wherein the network locations are protected.

48. The computer-readable media of claim 34, wherein the at least one rule is associated with the content.

49. The computer-readable media of claim 34, wherein the at least one rule is protected in a content header.

50. The computer-readable media of claim 34, wherein the at least one rule is received from a server with a content license.

51. The computer-readable media of claim 34, wherein the at least one rule is based on information from a SIM card.

52. The computer-readable media of claim 34, wherein the at least one rule is based on service operator information.

53. The computer-readable media of claim 41, wherein the network locations are protected.

54. The computer-readable media of claim 1, wherein the operational instructions further receive a download of an application after connecting to the network location.

55. The computer-readable media of claim 10, wherein the operational instructions further receive a download of an application after connecting to the network location.

56. The computer-readable media of claim 20, wherein the operational instructions further received a download of an application after connecting to the selected network location.

57. The computer-readable media of claim 34, wherein the operational instructions further receive a download of an application after connecting to the network location.
